(19) United States
(12) Patent Application Publication
(10) Pub. No.: US 2025/0362514 A1
(43) Pub. Date: Nov. 27, 2025

(54) HOLOGRAPHIC NEAR-EYE DISPLAY DEVICE WITH MULTI-ANGLE SIMULTANEOUS ILLUMINATION AND AN EYEBOX EXPANSION METHOD

(71) Applicants: Shanghai University, Shanghai (CN); VERSITECH LIMITED, Hong Kong (CN)

(72) Inventors: Xinxing XIA, Shanghai (CN); Yifan PENG, Hong Kong (CN); Huadong ZHENG, Shanghai (CN); Banghua YANG, Shanghai (CN); Yingjie YU, Shanghai (CN)

(21) Appl. No.: 19/294,216

(22) Filed: Aug. 7, 2025

Related U.S. Application Data
(63) Continuation of application No. PCT/CN2024/078030, filed on Feb. 22, 2024.

(30) Foreign Application Priority Data
Feb. 23, 2023 (CN) 202310156967.8

(51) Int. Cl. G02B 27/01; G02B 27/00; G02B 27/10; H04N 13/346; H04N 13/351; H04N 13/383

(52) U.S. Cl. CPC G02B 27/0172; G02B 27/0081; G02B 27/0093; G02B 27/106; H04N 13/346; H04N 13/351; H04N 13/383; G02B 2027/0174

(57) ABSTRACT

A holographic near-eye display device with multi-angle simultaneous illumination comprises a light source module, a spatial light modulator, a beam splitter, an eyepiece, and a master controller. The light source module emits parallel light at different angles and simultaneously illuminates and covers effective working area of spatial light modulator which, loaded with a hologram, modulates incident parallel light at different angles to form diffracted parallel light at different angles, that is, virtual images at different viewing angles. Parallel light at different angles illuminates spatial light modulator. After modulated and diffracted by calculated hologram on spatial light modulator, the diffracted image light is converged by second lens to form different viewpoints for human eye to view. In multi-angle simultaneous illumination, additional time-sharing control of illumination unit is not needed. When size and position of human eye pupil change, clear virtual image is always seen, achieving expanding the eyebox.

### CROSS-REFERENCE TO RELATED APPLICATIONS

The subject application is a continuation of PCT/CN2024/078030 filed on Feb. 22, 2024, which in turn claims priority on Chinese Patent Application No. CN202310156967.8 filed on Feb. 23, 2023 in China. The contents and subject matters of the PCT international stage application and the Chinese priority application are incorporated herein by reference.

### TECHNICAL FIELD

The present invention relates to the field of near-eye display technology, and more specifically, a holographic near-eye display device with multi-angle simultaneous illumination and an eyebox expansion method therefor.

### BACKGROUND ART

Holographic display is a technology that achieves three-dimensional reconstruction using interference fringes. Under the illumination of reference light, all information, comprising amplitude and phase, can be reconstructed through interference fringes. Traditional holographic reconstruction is realized through photosensitive materials. However, photosensitive materials cannot be rewritten and erased repeatedly. Moreover, holographic display systems based on photosensitive materials are susceptible to vibration. Therefore, traditional holographic technology is not suitable for virtual reality and augmented reality (VR/AR) displays.

With the rapid development of computer technology, holograms can now be calculated using algorithms. To display computer-generated holograms (CGH), spatial light modulators are used to load the calculated holograms, and virtual images are reconstructed through the diffraction modulation of the spatial light modulator, ultimately presenting them to the human eye through an eyepiece. Compared with traditional holographic technology, CGH has several advantages. First, holograms are generated by computers rather than being produced through the interference of photosensitive materials, which avoids the adverse effects of experimental environments and operational factors on hologram quality. Second, compared with optical holograms, the storage, transmission, and replication of calculated holograms are much easier, and holograms can even be transmitted in real-time and displayed remotely over the internet. Additionally, CGH can record information of virtual objects generated by 3D modeling software such as SolidWorks. Therefore, VR/AR devices based on CGH display are currently receiving increasing attention.

However, for near-eye display systems based on the principle of computed holography, the most prominent issue is that the total number of pixels of the spatial light modulator determines the space-bandwidth product of the display system, which limits the total amount of data the system can present, which, in turn, leads to a trade-off between the field of view (FOV) and the eyebox. Therefore, it is necessary to achieve a large eyebox for holographic near-eye display while ensuring that the viewing FOV meets normal viewing requirements.

Chinese Patent Application Publication CN113608352A discloses a holographic near-eye display system and eyebox expansion method based on exit pupil scanning. In the system, light emitted from a point light source is collimated by a lens and then illuminates a reflector, which reflects the light onto a beam splitter. The collimated light is reflected by the beam splitter onto the spatial light modulator, where it is modulated and diffracted by the loaded computed hologram. The diffracted image light is then focused onto the human eye through a lens. Meanwhile, an eye-tracking device is used to track the position of the human eye. The controller calculates the rotation angle and direction of the reflector, as well as the corresponding hologram loaded onto the spatial light modulator. By rotating the reflector, the direction of the collimated light incident on the spatial light modulator can be changed, allowing the hologram to be precisely focused onto the position of the human eye, thereby achieving the effect of expanding the eyebox. Chinese Patent Application Publication CN113608353A calculates the emission status of the corresponding position and color point light sources in the point light source array and the corresponding hologram loaded onto the spatial light modulator using a computer. By controlling the point light sources, the direction of the collimated light incident on the spatial light modulator is changed, allowing the hologram to be precisely focused onto the position of the human eye. However, these technologies require additional time-sharing control of the point light sources, and only one viewpoint is allowed to enter the human eye at a time. When no viewpoint or multiple viewpoints enter the human eye, image loss or aliasing may occur, affecting the normal viewing experience.

### SUMMARY OF THE PRESENT INVENTION

To address the existing technical issues, the present invention provides a holographic near-eye display device with multi-angle simultaneous illumination and an eyebox expansion method.

The present invention provides the following technical solutions.

The present invention provides a holographic near-eye display device with multi-angle simultaneous illumination, which comprises a light source module, a spatial light modulator, a beam splitter, an eyepiece, and a master controller, wherein the light source module is used to emit parallel light at different angles and simultaneously illuminate and cover the effective working area of the spatial light modulator; the spatial light modulator is located on the light-emitting side of the light source module and is connected to the master controller, and it is loaded with a hologram and is used to modulate the incident parallel light at different angles to form diffracted parallel light at different angles, that is, virtual images at different viewing angles; the beam splitter is used to reflect the diffracted parallel light carrying virtual images at different viewing angles to the eyepiece; the eyepiece is used to focus the diffracted parallel light carrying virtual images at different viewing angles into the human eye, forming different viewpoints; and the master controller is used to load the required hologram onto the spatial light modulator.

Furthermore, the hologram is composed of multiple sub-holograms, each of which corresponds to the parallel light at a different angle incident on the spatial light modulator, with one sub-hologram for each angle of parallel light.

Further, the holographic near-eye display device with multi-angle simultaneous illumination also comprises an eye-tracking system, which is connected to the master controller and is used to obtain the position information of the human eye pupil.

Preferably, the light source module comprises a first lens (110) and a multi-angle illumination unit (100) located at the front focal plane of the first lens (110). The multi-angle illumination unit (100) is used to provide illumination light at different angles, simultaneously illuminating and covering the effective working area of the spatial light modulator.

The multi-angle illumination unit (100) can be a combination of a one-dimensional or two-dimensional array of LED point light sources with narrowband filters, a one-dimensional or two-dimensional array of output ends of fiber-coupled lasers, or a point light source array composed of a surface light source and an active switch array. The active switch array can be a mechanical electronic pinhole shutter array or a liquid crystal switch array. The point light source (101) is a coherent light source that is simultaneously illuminated.

Preferably, the light source module comprises an illumination unit (200) and a holographic optical element (210). The illumination unit (200) is used to provide wide-beam spherical light or parallel light. The holographic optical element (210) diffracts the spherical light or parallel light provided by the illumination unit (200) to obtain reproduced parallel light beams at different angles. These light beams at different angles illuminate the effective working area of the spatial light modulator.

The holographic optical element (210) is a multi-angle multiplexed holographic optical element, which is prepared by recording plane or spherical reference light and plane signal light at different angles through time-sharing exposure. The wavelength of the light beam recorded by the holographic optical element (210) should correspond to the wavelength of the light beam emitted by the illumination unit (200).

Preferably, the light source module comprises an illumination unit (300), a collimating lens (310), a refracting prism (320), and a relay optical system (460). The illumination unit (300) is used to provide illumination light. The collimating lens (310) has the illumination unit (300) at its front focal plane and is used to generate wide-beam parallel light at different angles. The refracting prism (320) is used to split the wide-beam parallel light collimated by the collimating lens (310) into parallel light beams at different angles. These parallel light beams at different angles illuminate the effective working area of the spatial light modulator. The relay optical system (460) is a 4f optical relay system composed of a first relay lens (461) and a second relay lens (462). The common area where the spatial light modulator overlaps with the parallel light at different angles is located at the conjugate position of the 4f system, which is used to collect light and make full use of energy.

The refracting prism (320) is any prism that can split a light beam into multiple beams. When the wide-beam parallel light illuminates the refracting prism, after refraction by different surfaces of the prism, multiple parallel light beams at different angles can be generated.

The present invention further provides a method for holographic near-eye display with multi-angle simultaneous illumination and eyebox expansion, which comprises the following steps:
S1. calculate the complex amplitude distribution of the target plane observation image according to the three-dimensional scene to be displayed;
S2. calculate the complex amplitude distribution on the spatial light modulator plane based on the size and position of the human eye pupil, specifically as follows:
S2.1 determine the angles of the n parallel light beams at different angles that illuminate and cover the effective working area of the spatial light modulator θ₁, θ₂, . . . , θᵢ, . . . , θₙ;
S2.2 place the sub-holograms at their respective angles θᵢ and perform complex amplitude superposition on the target plane;
S2.3 based on the different sizes and positions of the human eye pupil, add different pupil filter M_{f} to simulate the changes in pupil size and position; optimize the hologram corresponding to the respective pupil size and position through multiple iterations until the composite hologram, which is the complex amplitude distribution on the spatial light modulator plane, is obtained;
S3. encode the complex amplitude distribution on the spatial light modulator plane into holographic image information;
S4. ensure that the n parallel light beams at different angles simultaneously illuminate and cover the effective working area of the spatial light modulator; load the holographic image information H onto the spatial light modulator to ensure that the human eye sees a clear virtual image.

Compared with the existing technologies, the present invention has the following obvious and significant advantages:

First, the device of the present invention uses parallel light at multiple angles to simultaneously illuminate and cover the spatial light modulator loaded with composite holograms corresponding to each angle of parallel light. The approach eliminates the need for additional time-sharing control and synchronization of point light sources, making the process simple and easy to implement. After being illuminated by parallel light at multiple angles, the spatial light modulator diffracts to produce virtual images at different viewing angles, which are then focused by a lens to form different viewpoints. When the size and position of the human eye pupil change, a clear virtual image can always be seen, thereby expanding the eyebox and avoiding image loss or aliasing that could affect the normal viewing experience.

Second, the device of the present invention uses a single-piece multi-angle multiplexed holographic optical element to generate parallel light at multiple angles for illuminating the spatial light modulator. The multi-angle multiplexed holographic optical element is prepared by recording plane or spherical reference light and plane signal light at different angles through time-sharing exposure. It has a single-piece structure and does not require additional complex optical components, thereby reducing the volume of the multi-angle illumination module and facilitating the construction of a compact near-eye display system.

Third, the method of the present invention employs a hologram optimization technique that takes into account the dynamic changes in the human eye pupil. When the size and position of the human eye pupil change, one or several adjacent viewpoints may simultaneously enter the pupil. During the hologram optimization process, pupil filter functions are added on the spectral plane of the eyepiece to simulate the changes in pupil size and position. The corresponding hologram for each pupil's size and position is optimized individually. By loading the optimized hologram onto the spatial light modulator, the human eye can always obtain a good viewing effect regardless of the pupil's size and position.

### BRIEF DESCRIPTION OF THE DRAWINGS

FIG. 1 shows the structure of the holographic near-eye display device with multi-angle simultaneous illumination using a multi-angle illumination unit as provided in Example 1 of the present invention.

FIG. 2 shows the two-dimensional array of point light sources in the multi-angle illumination unit, using a rectangular light source array as an example, in Example 1 of the present invention.

FIG. 3 shows the holographic near-eye display device with multi-angle simultaneous illumination using a multi-angle multiplexed holographic optical element in Example 2 of the present invention.

FIG. 4 shows the holographic near-eye display device with multi-angle simultaneous illumination using a refracting prism in Example 3 of the present invention.

FIG. 5 shows the three-dimensional structure of the refracting prism that splits a light beam into multiple beams as used in Example 3 of the present invention.

FIG. 6 shows the structure of the holographic near-eye display device with multi-angle simultaneous illumination using a refracting prism in Example 4 of the present invention.

FIG. 7 is a flowchart illustrating the method for expanding the eyebox using a holographic near-eye display device with multi-angle simultaneous illumination in the present invention.

Reference numbers in the figures refer to the following structure: 100 is the multi-angle illumination unit, 101 is the point light source, 110 is the first lens, 120 is the beam splitter, 130 is the spatial light modulator, 140 is the second lens, 150 is the master controller, 200 is the illumination unit, 210 is the holographic optical element, 300 is the illumination unit, 310 is the first lens, 320 is the refracting prism, 460 is the relay optical system, 461 is the first relay lens, and 462 is the second relay lens.

It should be understood that the above figures are illustrative and not drawn to scale.

### DETAILED DESCRIPTION OF THE PRESENT INVENTION

To make the objectives, technical solutions, and advantages of the embodiments of the present invention clearer, the following will describe the technical solutions in the embodiments of the present invention with reference to the accompanying drawings in the embodiments. It should be clear that the described embodiments are only a part of the embodiments of the present invention, and not all of them. Based on the embodiments of the present invention, all other embodiments obtained by those of ordinary skill in the art without making creative efforts are within the scope of protection of the present invention.

The above-mentioned solutions are further explained with specific examples as follows.

### Example 1. Holographic Near-Eye Display Device for Eyebox Expansion Based on Multi-Angle Simultaneous Illumination

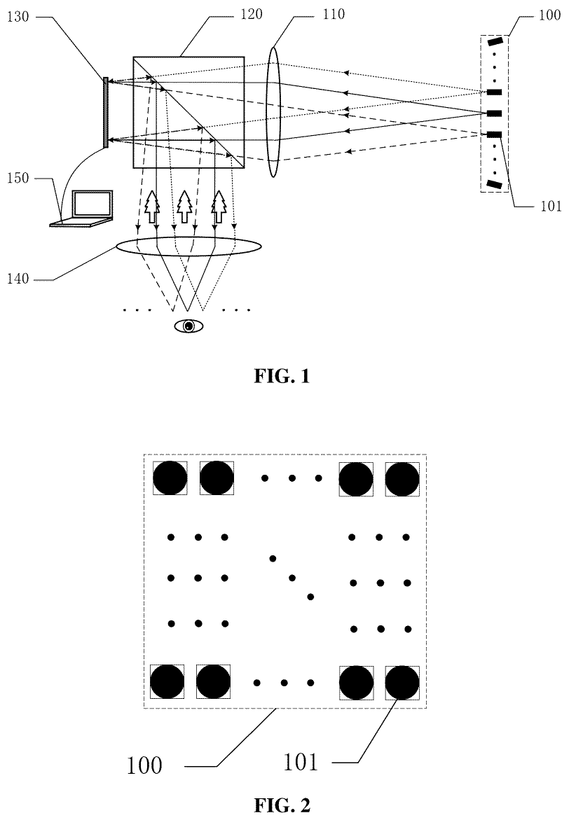

As shown in FIG. 1, the device comprises a multi-angle illumination unit 100, a first lens 110, a beam splitter 120, a spatial light modulator 130, a second lens 140, and a master controller 150.

In the example, the multi-Angle Illumination Unit 100 provides illumination light at different angles to simultaneously illuminate and cover the effective working area of the spatial light modulator. Typically, it consists of a one-dimensional or two-dimensional array of multiple point light sources 101, corresponding to one-dimensional or two-dimensional eyebox expansion. The arrangement of the multi-angle illumination unit 100 is related to the diffraction angle of the spatial light modulator 130 and the range of eyebox expansion. The multi-angle illumination unit 100 can be a combination of a one-dimensional or two-dimensional array of LED point light sources with narrowband filters, a one-dimensional or two-dimensional array of output ends of fiber-coupled lasers, or a point light source array composed of a surface light source and an active switch array. The active switch array can be a mechanical electronic pinhole shutter array or a liquid crystal switch array. The point light source 101 is a coherent light source that is simultaneously illuminated in this invention.

In the example, the multi-angle illumination unit 100 is located at the front focal plane of the first lens 110. The first lens 110 collimates the light beams emitted from the point light sources 101 in the multi-angle illumination unit 100 to produce wide-beam parallel light at different angles, ensuring that these parallel light beams illuminate and cover the effective working area of the spatial light modulator 130. The position of each point light source 101 in the multi-angle illumination unit 100 and the orientation of its optical axis determine the central angle of the emitted light. The relative position of the point light source 101 to the first lens 110 determines the angle of the collimated parallel light it produces. The spacing of the point light sources 101 in the multi-angle illumination unit 100 and the focal length of the first lens 110 determine the angular separation of the different parallel light beams. The relative position of the point light source 101, the orientation of its optical axis, and the focal length of the lens can be chosen based on the light source divergence angle, the diffraction angle of the spatial light modulator, and the range of eyebox expansion. The first lens 110 can be a single lens, a doublet lens, or a collimating lens group composed of multiple lenses.

In the example, the beam splitter 120 reflects the diffracted light beams from the spatial light modulator 130 to the second lens 140, which then converges the beams to the position where the human eye is located, allowing the observer to see the virtual image. The beam splitter 120 can be a plate beam splitter or a block beam splitter. A polarizer can also be placed in front of the beam splitter 120 to adjust the polarization state of the light beam to match that of the spatial light modulator 130.

In the example, the spatial light modulator 130 can be a reflective spatial light modulator of phase type, amplitude type, or hybrid amplitude-phase type. It diffracts and modulates the multi-angle parallel light incident on it, and the modulated light is reflected by the beam splitter 120 to the second lens 140. After being converged by the second lens 140, different viewpoints are formed for the human eye to observe the virtual image. The spatial light modulator 130 can also be a transmissive spatial light modulator.

In the example, the second lens 140 converges the diffracted parallel light at different angles from the spatial light modulator 130 to form different viewpoints. When the size and position of the human eye pupil change, a clear virtual image can always be seen.

In the example, the master controller 150 is generally connected to the spatial light modulator 130 through video interfaces such as HDMI, DVI, VGA, DisplayPort, USB, serial port, and general I/O, determining the control mode of the spatial light modulator 130. It is mainly used to control the display image, frame rate, resolution, and other parameters of the spatial light modulator 130.

In the example, a two-dimensional array arrangement of the point light sources 101 in the multi-angle illumination unit 100 is shown in FIG. 2. It should be noted that all the point light sources 101 in the present invention are simultaneously illuminated. The light beams generated by each point light source, after being collimated by the first lens 110, produce wide-beam parallel light at different angles. These wide-beam parallel light beams simultaneously illuminate and cover the effective working area of the spatial light modulator 130. After being diffracted and modulated, the light is reflected by the beam splitter 120 to the second lens 140, where it converges to form different viewpoints at the human eye, thereby achieving the effect of exit pupil expansion. The number and arrangement of the point light sources 101 in the multi- angle illumination unit 100 can be selected according to actual needs and system requirements, and the shape of the multi-angle illumination unit 100 can be rectangular, circular, or other shapes.

The point light sources 101 in the multi-angle illumination unit 100 are simultaneously illuminated, and the light beams at different angles, after being collimated by the first lens 110, simultaneously illuminate and cover the effective working area of the spatial light modulator 130. The hologram loaded on the spatial light modulator 130 is a composite hologram composed of multiple sub-holograms, each of which corresponds to the parallel light at a different angle incident on the spatial light modulator 130, with one sub-hologram for each angle of parallel light. All the sub-holograms are optimized and combined into a single composite hologram, which is loaded onto the spatial light modulator 130. After being illuminated by parallel light at different angles, the spatial light modulator 130 diffracts to produce virtual images at different viewing angles. These virtual images at different angles are focused by the second lens 140 to form different viewpoints simultaneously. In this case of multi-angle simultaneous illumination, there is no need for additional time-sharing control of the illumination unit. Moreover, when the size and position of the human eye pupil change, a clear virtual image can always be seen, thereby achieving the purpose of expanding the eyebox.

### Example 2

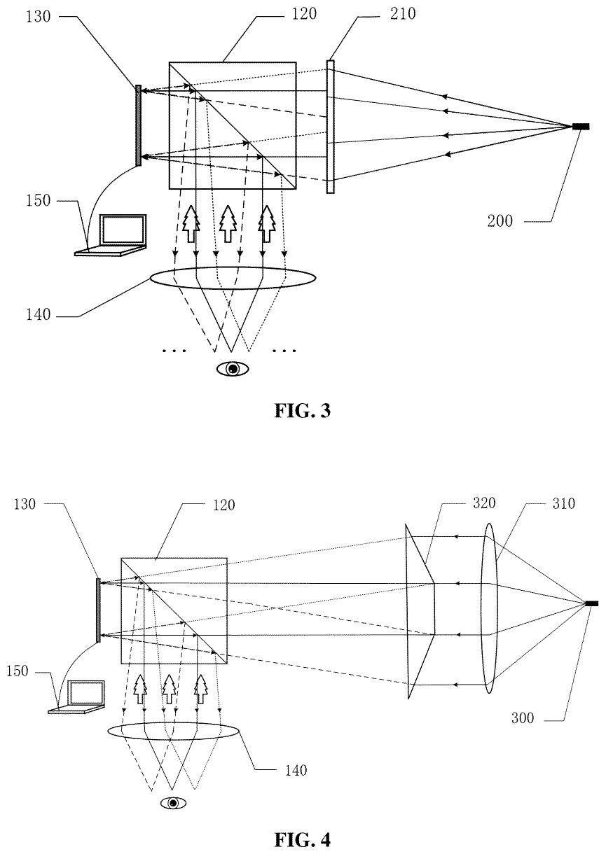

An embodiment of a holographic near-eye display device for pupil box expansion based on multi-angle simultaneous illumination is shown in FIG. 3. It comprises an illumination unit 200, a holographic optical element 210, a beam splitter 120, a spatial light modulator 130, a second lens 140, and a main controller 150.

The illumination unit 200 is used to provide wide-beam illumination light. The illumination light provided can be wide-beam spherical light or parallel light, or it can be a narrow beam combined with an expanding and collimating system. The spherical light or parallel light provided by the illumination unit 200 is projected onto the multi-angle multiplexed holographic optical element 210, which diffracts the light into different angles of reconstructed light beams that simultaneously illuminate and cover the effective working area of the spatial light modulator 130.

The holographic optical element 210 is a multi-angle multiplexed holographic optical element. When the spherical light or parallel light provided by the illumination unit 200 is projected onto the holographic optical element 210, it diffracts into reconstructed light beams at different angles. In FIG. 3, an example of three angles of multiplexing in the horizontal direction is shown to achieve one-dimensional pupil box expansion. It is also possible to use multiple angles of multiplexing in both the horizontal and vertical directions simultaneously to achieve two-dimensional pupil box expansion. In practice, any number of angles can be chosen for multiplexing in the horizontal and vertical directions according to the system requirements. The angle of the reconstructed light is determined based on the diffraction angle of the spatial light modulator and the range of pupil box expansion, and the corresponding holographic optical element is prepared accordingly to achieve one-dimensional or two-dimensional pupil box expansion. The holographic optical element 210 is generally prepared by recording plane or spherical reference light and parallel signal light at different angles through time-sharing exposure. After the spherical light or parallel light provided by the illumination unit 200 is diffracted by the holographic optical element 210, it produces reconstructed parallel light beams at different angles. These light beams simultaneously cover the effective working area of the spatial light modulator 130, which then diffracts to produce virtual images at different angles. These virtual images are converged by the second lens 140 to form different viewpoints for the human eye to view the virtual images, thereby achieving the effect of pupil box expansion.

In the actual preparation process, the holographic recording material can be fixed on a glass substrate first, and the holographic optical element 210 can be prepared through time-sharing exposure using the holographic exposure method. Alternatively, the prepared holographic optical element 210 can be bonded to the glass substrate using optical matching adhesive in a face-to-face bonding manner. The wavelength of the light beams recorded by the holographic optical element 210 should correspond to the wavelength of the light beams emitted by the illumination unit 200. Common holographic recording materials comprise silver halide emulsion, dichromate gelatin, photoresist, photopolymer, and photo-thermoplastic. Photopolymer holographic recording material has the advantages of high sensitivity and diffraction efficiency, convenient processing, and real-time dry development.

The beam splitter 120 reflects the diffracted light beams from the spatial light modulator 130 to the second lens 140, which converges the light beams to the position of the human eye for the observer to view the virtual image. The beam splitter 120 can be a plate beam splitter or a block beam-splitting prism. A polarizer can also be placed in front of the beam splitter 120 to adjust the polarization state of the light beams to match that of the spatial light modulator 130.

The spatial light modulator 130 can be a reflective spatial light modulator of the phase-type, amplitude-type, or hybrid amplitude-phase type. It diffracts and modulates the parallel light incident upon it, and the modulated light is reflected by the beam splitter 120 to the second lens 140. The second lens 140 converges the light to the position of the human eye, allowing the observer to view the virtual image. The spatial light modulator 130 can also be a transmissive spatial light modulator.

The second lens 140 converges the diffracted parallel light beams at different angles from the spatial light modulator 130 to form different viewpoints. When the size and position of the human eye's pupil change, the observer can still see a clear virtual image. The main controller 150 is generally connected to the spatial light modulator 130 through video interfaces such as HDMI, DVI, VGA, DisplayPort, USB, serial ports, and general-purpose I/O. It determines the control mode of the spatial light modulator 130 and is mainly used to control the display image, frame rate, resolution, and other parameters of the spatial light modulator 130.

The spherical light or parallel light provided by the illumination unit 200 is projected onto the holographic optical element 210 and diffracted into reconstructed light beams at different angles, illuminating and covering the effective working area of the spatial light modulator 130. The hologram loaded onto the spatial light modulator 130 is a composite hologram composed of multiple sub-holograms. Each sub-hologram corresponds to parallel light at a different angle incident upon the spatial light modulator 130, with each angle of parallel light corresponding to one sub-hologram. By optimizing the combination of all sub-holograms into a single composite hologram and loading it onto the spatial light modulator 130, different perspectives of virtual images are diffracted when the spatial light modulator 130 is illuminated by parallel light at different angles. These virtual images at different angles are converged by the second lens 140 to form different viewpoints simultaneously.

The approach of using a multi-angle multiplexed holographic optical element to achieve simultaneous multi-angle illumination of the spatial light modulator does not require additional time-sharing control of the illumination unit. Moreover, when the size and position of the human eye's pupil change, a clear virtual image can always be seen, thereby achieving the goal of pupil box expansion.

### Example 3

The present invention provides an embodiment of a holographic near-eye display device for pupil box expansion based on multi-angle simultaneous illumination as shown in FIG. 4. The holographic near-eye display device for pupil box expansion based on multi-angle simultaneous illumination comprises a lighting unit 300, a collimating lens 310, a refracting prism 320, a beam splitter 120, a spatial light modulator 130, a second lens 140, and a main controller 150.

The lighting unit 300 is used to provide wide-beam illumination light. The illumination light, after passing through the collimating lens 310, generates a wide-beam parallel light. The wide-beam parallel light is then directed onto the refracting prism 320, where it is refracted by different surfaces of the prism to produce parallel light beams at different angles that illuminate and cover the effective working area of the spatial light modulator 130.

The refracting prism 320 is used to split the wide-beam parallel light generated by the collimating lens 310 into parallel light beams at different angles. As shown in FIG. 4, after passing through the refracting prism 320, the parallel light beam is divided into three parallel light beams at different angles in the horizontal direction. These three parallel light beams at different angles simultaneously illuminate the spatial light modulator 130 and cover its effective working area. The spatial light modulator 130 diffracts to produce virtual images at different viewing angles. These virtual images at different angles are converged by the second lens 140 to form different viewpoints, thereby achieving the one-dimensional expansion of the pupil box. The beam splitter 120 reflects the diffracted light beams from the spatial light modulator 130 onto the second lens 140, which converges the light beams to the position of the human eye for observation of the virtual image. The beam splitter 120 can be a plate beam splitter or a block beam-splitting prism. A polarizer can also be placed in front of the beam splitter 120 to adjust the polarization state of the light beams to match that of the spatial light modulator 130.

The spatial light modulator 130 can be a reflective spatial light modulator of phase-only, amplitude-only, or hybrid amplitude-phase type. It diffracts and modulates the multi-angle parallel light beams incident upon it. The modulated light is then reflected by the beam splitter 120 to the second lens 140, which converges the light to the position of the human eye for observation of the virtual image. The spatial light modulator 130 can also be a transmissive spatial light modulator.

The second lens 140 converges the diffracted light beams at different angles from the spatial light modulator 130 to form different viewpoints. When the size and position of the human eye's pupil change, a clear virtual image can still be seen. The main controller 150 is generally connected to the spatial light modulator 130 through video interfaces such as HDMI, DVI, VGA, DisplayPort, USB, serial port, and general-purpose I/O. It determines the control mode of the spatial light modulator 130 and is mainly used to control the display image, frame rate, resolution, etc., of the spatial light modulator 130.

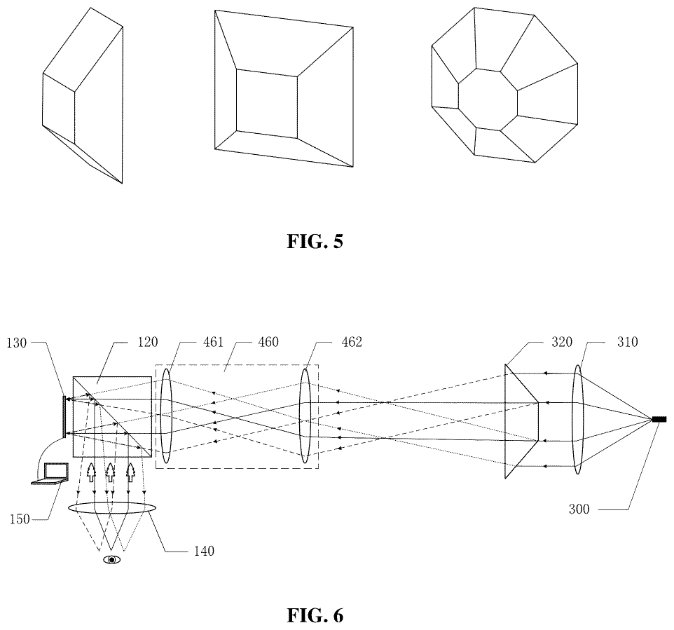

The refracting prism 320 is not limited to the 1-to-3 splitting prism shown in FIG. 4. It can be any prism that splits the light beam into multiple beams. FIG. 5 shows refracting prisms that split the light beam into three, five, or nine beams. When a wide-beam parallel light illuminates the refracting prism, multiple parallel light beams at different angles are generated after refraction by the different surfaces of the prism. These multiple parallel light beams at different angles simultaneously illuminate the effective working area of the spatial light modulator 130. After diffraction by the spatial light modulator 130, virtual images at different viewing angles are produced. These virtual images are converged by the second lens 140 to form different viewpoints, thereby achieving one-dimensional or two-dimensional expansion of the pupil box. The actual prism used can be designed and manufactured according to the diffraction angle of the spatial light modulator, the expansion range of the pupil box, and the required precision, by adjusting the angles between the refracting surfaces of the prism and the size of the prism to meet the working requirements of the system.

The light beam provided by the illumination unit 300 is collimated by the collimating lens 310 and then directed onto the refracting prism 320. After refraction by different surfaces of the refracting prism 320, parallel light beams at different angles are generated. These parallel light beams at different angles illuminate and cover the effective working area of the spatial light modulator 130.

The hologram loaded onto the spatial light modulator 130 is a composite hologram composed of multiple sub-holograms. Each sub-hologram corresponds to the parallel light at a different angle incident upon the spatial light modulator 130, with one sub-hologram for each angle of parallel light. All the sub-holograms are optimized and combined into a single composite hologram, which is then loaded onto the spatial light modulator 130. When the spatial light modulator 130 is illuminated by parallel light beams at different angles, it diffracts to produce virtual images at different viewing angles. These virtual images at different angles are converged by the second lens 140 to form different viewpoints.

In the configuration where the refracting prism is used to achieve multi-angle simultaneous illumination of the spatial light modulator, there is no need for additional time-division control of the illumination unit. When the size and position of the human eye's pupil change, a clear virtual image can always be seen, thereby achieving the goal of expanding the eye pupil box.

### Example 4

The present invention provides an example of a holographic near-eye display device for pupil box expansion based on multi-angle simultaneous illumination as shown in FIG. 6. The holographic near-eye display device for pupil box expansion based on multi-angle simultaneous illumination comprises a lighting unit 300, a collimating lens 310, a refracting prism 320, a beam splitter 120, a spatial light modulator 130, a second lens 140, a master controller 150, and a relay optical system 460.

The lighting unit 300 is used to provide wide-beam illumination light. The illumination light passes through the collimating lens 310 to produce wide-beam parallel light. The wide-beam parallel light is then incident on the refracting prism 320. After being refracted by different surfaces of the refracting prism 320, the parallel light is split into parallel light beams at different angles, which simultaneously cover the effective working area of the spatial light modulator 130.

The refracting prism 320 is used to split the wide-beam parallel light collimated by the collimating lens 310 into parallel light beams at different angles. After passing through the refracting prism 320, a single parallel light beam is transformed into multiple parallel light beams at different angles. These multiple parallel light beams at different angles simultaneously illuminate and cover the effective working area of the spatial light modulator 130. The spatial light modulator 130 diffracts the light to produce virtual images at different viewing angles. The virtual images at different angles are converged by the second lens 140 to form different viewpoints. When the size and position of the human eye pupil change, a clear virtual image can always be seen, thus achieving the effect of pupil box expansion.

The relay optical system 460 is an imaging system composed of a first relay lens 461 and a second relay lens 462. It ensures that the effective working area of the spatial light modulator 130 and the overlapping region of the multiple parallel light beams at different angles are essentially in a conjugate relationship, with some allowable deviation. The basic structure of the relay optical system 460 is a 4f optical system, where the optical axes of the first relay lens 461 and the second relay lens 462 coincide, and the rear focal point of the first relay lens 461 coincides with the front focal point of the second relay lens 462. The overlapping region of the spatial light modulator 130 and the multiple parallel light beams at different angles is located at the conjugate position of the 4f system, which is used to collect light and make full use of energy. A spatial filter can be added to the intermediate focal plane of the 4f system to improve image quality. The relay optical system 460 can also be a deformed 4f optical system, composed of a first relay lens 461 with a first focal length f1 and a second relay lens 462 with a second focal length f2. It is used to enlarge or reduce the size of the light beam incident on the spatial light modulator 130, ensuring the full utilization of illumination light energy and making the spatial layout of the system more rational. The first relay lens 461 can be a single lens, a doublet lens, or a lens group composed of multiple lenses. The second relay lens 462 can also be a single lens, a doublet lens, or a lens group composed of multiple lenses.

The beam splitter 120 reflects the diffracted light beam from the spatial light modulator 130 to the second lens 140, which converges the light beam to the position of the human eye for observation of the virtual image. The beam splitter 120 can be a plate beam splitter or a block beam splitter. A polarizer can also be placed in front of the beam splitter 120 to adjust the polarization state of the light beam to match that of the spatial light modulator 130.

The spatial light modulator 130 can be a reflective spatial light modulator of phase-type, amplitude-type, or amplitude-phase hybrid type. It diffracts and modulates the multi-angle parallel light beams incident on it. After being reflected by the beam splitter 120, the modulated light reaches the second lens 140. The second lens 140 converges the light to the position of the human eye, where the virtual image can be observed. The spatial light modulator 130 can also be a transmissive spatial light modulator.

The second lens 140 converges the diffracted parallel light beams at different angles from the spatial light modulator 130 to form different viewpoints. When the size and position of the human eye pupil change, a clear virtual image can always be seen. The master controller 150 is generally connected to the spatial light modulator 130 through video interfaces such as HDMI, DVI, VGA, DisplayPort, or through USB, serial ports, and general I/O. It determines the control mode of the spatial light modulator 130 and is mainly used to control the display image, frame rate, resolution, etc., of the spatial light modulator 130.

The light beam provided by the lighting unit 300 is collimated by the collimating lens 310 and then illuminates the refracting prism 320. After being refracted by different surfaces of the refracting prism 320, the light is split into parallel light beams at different angles. These parallel light beams pass through the relay optical system 460 and illuminate and cover the effective working area of the spatial light modulator 130. The hologram loaded on the spatial light modulator 130 is a composite hologram composed of multiple sub-holograms. Each sub-hologram corresponds to the parallel light beam at a different angle incident on the spatial light modulator 130. Each angle of parallel light corresponds to one sub-hologram. All sub-holograms are optimized and combined into a composite hologram, which is loaded onto the spatial light modulator 130. After being illuminated by the parallel light beams at different angles, the spatial light modulator 130 diffracts to produce virtual images at different viewing angles. These virtual images at different angles are converged by the second lens 140 to form different viewpoints. The method of using a refracting prism to achieve multi-angle simultaneous illumination of the spatial light modulator does not require additional time-sharing control of the lighting unit. When the size and position of the human eye pupil change, a clear virtual image can always be seen, thus achieving the purpose of expanding the pupil box.

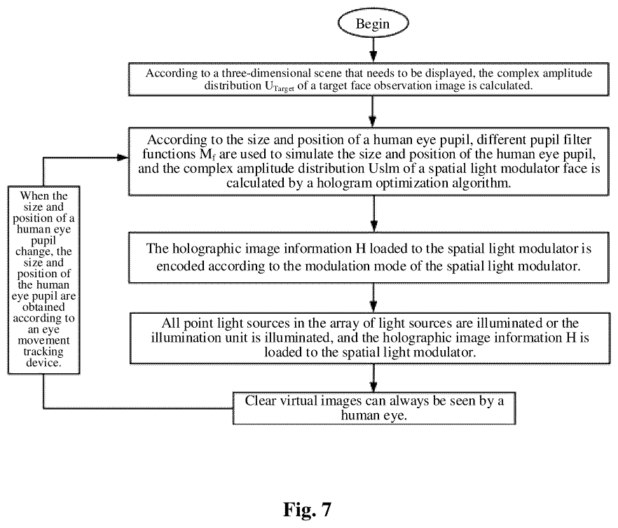

The size and position of the human eye pupil have a dynamic range of variation. Considering the different sizes and positions of the human eye pupil, there may be one viewpoint or several adjacent viewpoints entering the human eye pupil. To achieve better image quality at one or several adjacent viewpoints, an eye-tracking system can be added to the system. The method involves optimizing the corresponding hologram based on the viewpoint position. When the size and position of the human eye pupil change, the eye-tracking system detects the viewpoint position of the human eye. During the hologram optimization process, a pupil filter function is added to the spectral plane of the eyepiece to simulate the changes in the size and position of the human eye pupil. The hologram corresponding to the specific pupil size and position is optimized separately. The spatial light modulator loads the optimized hologram, ensuring good viewing quality for the human eye at different pupil sizes and positions. The schematic flowchart of the holographic near-eye display device based on multi-angle simultaneous illumination and the method for expanding the pupil box provided in this invention is shown in FIG. 7. The method comprises the following steps:
Step 1: based on the required three-dimensional scene, calculate the complex amplitude distribution UTarget of the observation image on the target plane using methods such as point source method, angular spectrum method, Fresnel diffraction, or Fraunhofer diffraction.
Step 2: calculate the complex amplitude distribution USLM on the spatial light modulator plane using algorithms such as the Stochastic Gradient Descent (SGD) algorithm, Gerchberg-Saxton (GS) algorithm, or Wirtinger algorithm. In this invention, the hologram loaded on the spatial light modulator is a composite hologram composed of multiple sub-holograms. Each sub-hologram corresponds to the parallel light beam at a different angle incident on the spatial light modulator, with each angle of parallel light corresponding to one sub-hologram. All sub-holograms are optimized and combined into a composite hologram. Considering the different sizes and positions of the human eye pupil, during the hologram optimization process, a pupil filter function is added to the spectral plane of the eyepiece to simulate the changes in the size and position of the human eye pupil. The hologram corresponding to the specific pupil size and position is optimized separately. The specific calculation process is as follows:
1. determine the angles θ₁, θ₂, . . . , θᵢ, . . . , θₙ of the n parallel beams of light that are incident on the spatial light modulator according to the number and positions of point light sources in the multi-angle illumination unit;
2. in one iteration of the above algorithm, the sub-holograms are propagated at the respective angles θᵢ and superposed in terms of complex amplitude on the target plane;
3. according to the different sizes and positions of the human eye pupil, different pupil filter functions Mf are added on the spectral plane of the eyepiece to simulate the changes in the size and position of the human eye pupil, and the holograms corresponding to the respective pupil sizes and positions are optimized. Performing iterations many times and optimize until a composite hologram is ultimately obtained, namely, the complex amplitude distribution of the spatial light modulator face Uₛₗₘ of the spatial light modulator surface.
Step 3: the complex amplitude distribution Uₛₗₘ on the spatial light modulator (SLM) surface is encoded into the corresponding holographic image information H to be loaded onto the SLM according to the modulation method of the SLM.
Step 4: all point light sources in the multi-angle illumination unit are turned on to achieve multi-angle simultaneous illumination, and the holographic image information H is loaded onto the SLM; or the illumination unit is turned on, and multi-angle simultaneous illumination is achieved through a holographic optical element or a refractive prism, and the holographic image information H is loaded onto the SLM.
Step 5: when the size and position of the human eye pupil change, the above optimization process is used to ensure that the human eye can always see a clear virtual image.

In summary, the above examples provide a holographic near-eye display device and a pupil box expansion method based on multi-angle simultaneous illumination.

Specifically, in Example 1, the holographic near-eye display device and pupil box expansion method is realized through a multi-angle illumination unit. The device comprises a multi-angle illumination unit, a first lens, a beam splitter, a spatial light modulator (SLM), a second lens, and a master controller. The point light sources in the multi-angle illumination unit are turned on simultaneously. Light beams at different angles are collimated by the first lens and then simultaneously illuminate and cover the effective working area of the SLM. A composite hologram composed of multiple sub-holograms is loaded onto the SLM. After being illuminated by parallel light beams at different angles, the SLM diffracts to produce virtual images at different viewing angles. The virtual images at different angles are focused by the second lens to form different viewpoints. The multi-angle simultaneous illumination approach does not require additional time-sharing control of the illumination unit. When the size and position of the human eye pupil change, the human eye can always see a clear virtual image, thereby achieving the purpose of expanding the pupil box.

In Example 2, the holographic near-eye display device and pupil box expansion method is realized through a multi-angle multiplexed holographic optical element. The device comprises an illumination unit, a holographic optical element, a beam splitter, a spatial light modulator (SLM), a second lens, and a master controller. The spherical or parallel light provided by the illumination unit can be diffracted by the holographic optical element to produce light beams at different angles. These light beams at different angles cover the effective working area of the SLM. A composite hologram is loaded onto the SLM, which then diffracts to produce virtual images at different viewing angles after being illuminated by parallel light beams at different angles. The virtual images at different angles are focused by the second lens to form different viewpoints. The approach using a multi-angle multiplexed holographic optical element for simultaneous illumination of the SLM does not require additional time-sharing control of the illumination unit. When the size and position of the human eye pupil change, the human eye can always see a clear virtual image, thereby achieving the purpose of expanding the pupil box.

Finally, in Examples 3 and 4, these holographic near-eye display devices and pupil box expansion methods are realized through a refractive prism. The device comprises an illumination unit, a collimating lens, a refractive prism, a beam splitter, a spatial light modulator (SLM), a second lens, and a master controller. The light beam provided by the illumination unit is collimated by the collimating lens and then illuminates the refractive prism. After refraction by different surfaces of the refractive prism, parallel light beams at different angles are produced, which cover the effective working area of the SLM. A composite hologram is loaded onto the SLM, which then diffracts to produce virtual images at different viewing angles after being illuminated by parallel light beams at different angles. The virtual images at different angles are focused by the second lens to form different viewpoints. The approach using a refractive prism for simultaneous illumination of the SLM does not require additional time-sharing control of the illumination unit. When the size and position of the human eye pupil change, the human eye can always see a clear virtual image, thereby achieving the purpose of expanding the pupil box.

Finally, it should be noted that the above embodiments are merely used to illustrate the technical solutions of the present invention and are not intended to limit them. Under the concept of the present invention, the technical features in the above embodiments or between different embodiments can also be combined, and the steps can be implemented in any order. There are many other variations of the different aspects of the present invention as described above. Although the present invention has been described in detail with reference to the foregoing embodiments, those of ordinary skill in the art should understand that they can still modify the technical solutions described in the foregoing embodiments or replace some of the technical features with equivalents. Such modifications or substitutions do not cause the nature of the corresponding technical solutions to depart from the scope of the technical solutions of the present invention as embodied in the various embodiments.

We claim:

1. A multi-angle simultaneously illuminating holographic near-eye display device, comprising
a light source module,
a spatial light modulator,
a beam splitter,
an eyepiece, and
a general controller,
wherein the light source module emits parallel light at different angles and simultaneously illuminates and covers an effective working area of the spatial light modulator;
the spatial light modulator is arranged at a light-emitting side of the light source module and connected to the general controller, is loaded with a hologram, and forms diffracted parallel light at different angles after modulating parallel light at different angles of incidence that are virtual images at different viewing angles;
the beam splitter reflects diffracted parallel light of virtual images with different viewing angles to the eyepiece;
the eyepiece converges diffracted parallel light of virtual images with different viewing angles into a human eye to form different viewpoints; and
the general controller loads a desired hologram on the spatial light modulator.

2. The multi-angle simultaneously illuminating holographic near-eye display device according to claim 1, wherein the hologram is a combination of a plurality of sub-holograms, each sub-hologram corresponds to a parallel light at a different angle irradiating on the spatial light modulator, and one sub-hologram corresponds to each angle of parallel light.

3. The multi-angle simultaneously illuminating holographic near-eye display device according to claim 1, further comprising
an eye movement tracking system connected to the general controller for acquiring position information about a pupil of a human eye.

4. The multi-angle simultaneously illuminating holographic near-eye display device according to claim 1, wherein the light source module comprises
a first lens (110), and
a multi-angle illumination unit (100) located at a front focal plane of the first lens (110),
wherein the multi-angle illumination unit (100) provides illumination lights at different angles while illuminating and covering the effective operating area of the spatial light modulator.

5. The multi-angle simultaneously illuminating holographic near-eye display device according to claim 4, wherein the multi-angle illumination unit (100) is a combination of an LED point light source array and a narrow-band filter arranged in one dimension or two dimensions.

6. The multi-angle simultaneously illuminating holographic near-eye display device according to claim 4, wherein the multi-angle illumination unit (100) is an output end array of an optical fiber coupled laser arranged in one dimension or two dimensions.

7. The multi-angle simultaneously illuminating holographic near-eye display device according to claim 4, wherein the multi-angle illumination unit (100) is a point light source array composed of a surface light source and an active switch array, the active switch array can be a mechanical electronic orifice shutter array or a liquid crystal switch array; and
the point light source (101) is a coherent light source being illuminated at the same time.

8. The multi-angle simultaneously illuminating holographic near-eye display device according to claim 1, wherein the light source module comprises an illumination unit (200) and a holographic optical element (210);
the illumination unit (200) provides a broad beam of spherical light or parallel light; and
the holographic optical element (210) diffracts the spherical light or the parallel light provided by the illumination unit (200) to obtain reproduction parallel light beams at different angles, and the reproduction light beams at different angles irradiate on the effective working area of the spatial light modulator.

9. The multi-angle simultaneously illuminating holographic near-eye display device according to claim 8, wherein the holographic optical element (210) is a multi-angle multiplexing holographic optical element prepared by time-division exposure of recording planar or spherical reference light and planar signal light of different angles; and
a wavelength of a recorded light beam of the holographic optical element (210) corresponds to a wavelength of the light beam emitted by the illuminating unit (200).

10. The multi-angle simultaneously illuminating holographic near-eye display device according to claim 1, wherein the light source module comprises an illumination unit (300), a collimating lens (310), a refracting prism (320) and a relay optical system (460);
the illumination unit (200) provides illumination light;
a front focal plane of the collimating lens (310) is provided with the illumination unit (300) for generating wide beam parallel light at different angles;
the refracting prism (320) splits a wide beam of parallel light generated by the collimation of the collimating lens (310) into parallel light beams with different angles, and the parallel lights with different angles irradiate on the effective working area of the spatial light modulator; and
the relay optical system (460) is a 4f optical relay system composed of a first relay lens (461) and a second relay lens (462), and a common region where the spatial light modulator coincides with parallel lights of different angles is located at a conjugate position of the 4f system, and collects light to make full use of energy.

11. The multi-angle simultaneously illuminating holographic near-eye display device according to claim 10, wherein the refracting prism (320) is a random refracting prism that divides a light beam into more than one, and a wide beam of parallel light is irradiated onto the refracting prism; and
after the wide beam of parallel light is refracted by different surfaces of the refracting prism, multiple parallel light beams with different angles is generated.

12. A multi-angle simultaneously illuminating holographic near-eye display and eye pupil box expansion method, comprising steps of:
S1. according to a three-dimensional scene required to be displayed, calculating a complex amplitude distribution of a target face observation image;
S2. according to a pupil size and position of a human eye pupil, calculating a complex amplitude distribution of a spatial light modulator face, specifically:
S2.1 determining that angles of n beams of parallel lights at different angles illuminating and covering an effective working area of the spatial light modulator are respectively θ₁, θ₂, . . . , θᵢ, . . . , θₙ;
S2.2 propagating sub-holograms under a corresponding θᵢ respectively, and superimposing same in complex amplitude at a target plane; and
S2.3 according to different sizes and positions of human eye pupils, adding different pupil filter functions Mf to a frequency spectrum face of an eyepiece to simulate changes in the sizes and positions of human eye pupils, optimizing holograms corresponding to sizes and positions of corresponding pupils, and performing iterations multiple times until a composite hologram is obtained that is a complex amplitude distribution of the spatial light modulator face;
S3. encoding the complex amplitude distribution of the spatial light modulator face into holographic image information; and
S4. simultaneously illuminating the n beams of parallel lights of different angles and covering the effective working area of the spatial light modulator, and loading holographic image information H on the spatial light modulator to ensure that a clear virtual image is visible to a human eye.

13. The multi-angle simultaneously illuminating holographic near-eye display and eye pupil box expansion method according to claim 12, wherein when the size and position of the human eye pupil changes, an updated size and position of the human eye pupil is obtained by using an eye movement tracking device. and steps S2 to S4 are repeated.
